(19) United States
(12) Patent Application Publication
(10) Pub. No.: US 2022/0196027 A1
(43) Pub. Date: Jun. 23, 2022

(54) INLINE, ONE MOVING PART PUMP FOR ISOLATED FLUID CHANNELS

(71) Applicant: Sapphire Motors, San Leandro, CA (US)

(72) Inventors: Tracy MCSHEERY, San Mateo, CA (US); Carl PAGE, Palo Alto, CA (US)

(21) Appl. No.: 17/128,002

(22) Filed: Dec. 18, 2020

(51) Int. Cl. F04D 29/18; H02K 7/08; H02K 7/14; F04D 13/06; F04D 29/041

(52) U.S. Cl. CPC F04D 29/181; H02K 7/08; F04D 29/0413; F04D 13/06; H02K 7/14

(57) ABSTRACT

A pump assembly can pump fluid with a single moving part, where the single moving part is free floating, inline within a sealed fluid path. The pump includes a stator core having a cylindrical shape with an opening through it. The stator includes electromagnetic coils arranged around a lateral surface of the stator core extending away from the center of the stator core. The pump assembly includes an impeller to spin within the cylindrical opening of the stator in response to selective charging of the electromagnetic coils. The impeller includes a cylindrical body having blades that align with the electromagnetic coils to create a magnetic flux path between selected coils through the impeller in response to selective charging of the electromagnetic coils.

### FIELD

Descriptions are generally related to pumps, and more particular descriptions are related to integrated inline pumps.

### BACKGROUND

Pumps are used for countless scenarios, from large pumps to small pumps. Some pump applications are constrained by expensive pumps to provide proper sealing for liquids that need to remain in an isolated fluid channel, whether because of fluid temperature or to keep contaminates out of the fluid. Regardless of the pump design, the sealing of the pump becomes an issue because the pumps need a motor to drive them. Traditional pump systems include a motor with an axle that turns the pump impeller. From that perspective, many pumps are considered to have a single moving part, but when the system is considered as a whole, there are alignment tolerances and shaft seals that create failure points in the system.

One application of pumps that has gained increased attention due to the applications in solar heating, heat storage, and nuclear reactor cooling is molten salts. Molten salts can be used to refer to fluids used for cooling that are solid at room temperature, but have a viscosity similar to water at high temperatures. When salts or ionic compounds have operational temperatures, or temperatures at which they are or can be pumped through a system, of less than approximately 200 degrees Celsius, they can be referred to as ionic fluids. When the operational temperature of the ionic fluid is above approximately 200 degrees C., they are often referred to as molten salt.

Most hot fluid applications, such as the pumping of molten salts, prioritize reliability and serviceability over cost and volumetric power density. Thus, the pumps tend to be very expensive. Additionally, the pumps are typically designed for ensuring sealing and operation of the pump in ways that can result in lower efficiency pumping.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1A is a side view of an example of an impeller and stator core for a pump.

FIG. 1B is a perspective view of an example of an impeller and stator core for a pump.

FIG. 2 is a perspective view of an example of a floating impeller for a pump.

FIG. 3A is an example of a pump stator and impeller with a foil bearing on an end of the impeller.

FIG. 3B is an example of the pump stator and impeller of FIG. 3A with a bearing structure over the stator core.

FIG. 4 is an example of magnetic reluctance operation for a pump assembly.

FIG. 5A is an example of a pump assembly.

FIG. 5B is an example of a pump assembly with an outer housing.

FIG. 6 is an example of a pump assembly coupled to a pipe.

Descriptions of certain details and implementations follow, including non-limiting descriptions of the figures, which may depict some or all examples, and well as other potential implementations.

### DETAILED DESCRIPTION

As described herein, a pump assembly can pump fluid with a single moving part, where the single moving part is free floating, inline within a sealed fluid path. The pump is integrated with the motor in that the entire pump and motor assembly are integrated. The pump and motor assembly includes a single moving part, which is the impeller, which acts as a rotor and impeller. The motor includes a stator to drive the impeller/rotor. The stator can have a stator having a cylindrical shape with an opening through it. Thus, the pump is inline with the fluid channel in that the cylindrical opening through the stator core and thus through the pump/motor integration can be made to match the diameter of the fluid channel. Thus, the pump and motor assembly can be integrated inline with piping for the fluid.

Pumps can pump various types of fluid, where a fluid is generally understood to refer to liquids and gases or other substances that can be classified as a fluid. In essence, the fundamental components of a pump are the impeller, which creates velocity in the fluid through rotation, and the casing, which converts velocity into pressure. The rotation of the impeller creates velocity in the fluid. The shape and fit of the impeller in the stator core converts the velocity into pressure, which causes the fluid to flow.

The stator includes electromagnetic coils arranged around a lateral surface of the stator core extending away from the center of the stator core. The electromagnetic coils can be wrapped around slots connected to the outer surface or the lateral surface of the stator body. The pump assembly includes an impeller to spin within the cylindrical opening of the stator in response to selective charging of the electromagnetic coils. The impeller includes a cylindrical body having blades or fins or vanes that align with the electromagnetic coils to create a magnetic flux path between selected or charged coils through the impeller in response to selective charging of the electromagnetic coils. The selected coils can be charged to create north and south poles on slots that are slightly offset (leading) the blades of the impeller. The magnetic reluctance between the charged coils (electromagnets) and the impeller blades, pulls the blades to align with the slots, thus spinning the impeller. More details are provided below.

As described in more detail below, there are many potential applications for the integrated, inline motor and pump described. There are applications in the pumping of extreme temperature fluids. One area of interest is in the pumping of high temperature fluids, such as molten salt. Another area of interest is in the pumping of low temperature fluids such as liquid nitrogen. The pumping of extreme temperature fluids illustrates the value of inline pumping, where a shaft seal or the need to insulate the environment from the fluid, or insulate the fluid from the environment, is needed. The pump described can pump any fluid or liquid, and can provide significant advantages over traditional pumps for liquids that are pumped in a state that has low thermal expansion as it is pumped, and thus has lower lateral loading on the pump sidewalls. Advantages can include structural and operational design that provide significant performance improvements in low pressure pumping environments.

The integrated pump described can provide an inline pump, where the fluid flows right through the middle of the pump. The impeller is the only moving component of the motor, which can be suspended in the fluid path. Other than floating the impeller in the fluid path, the only thing that penetrates the fluid path is the magnetic field applied to spin the impeller to pump the fluid.

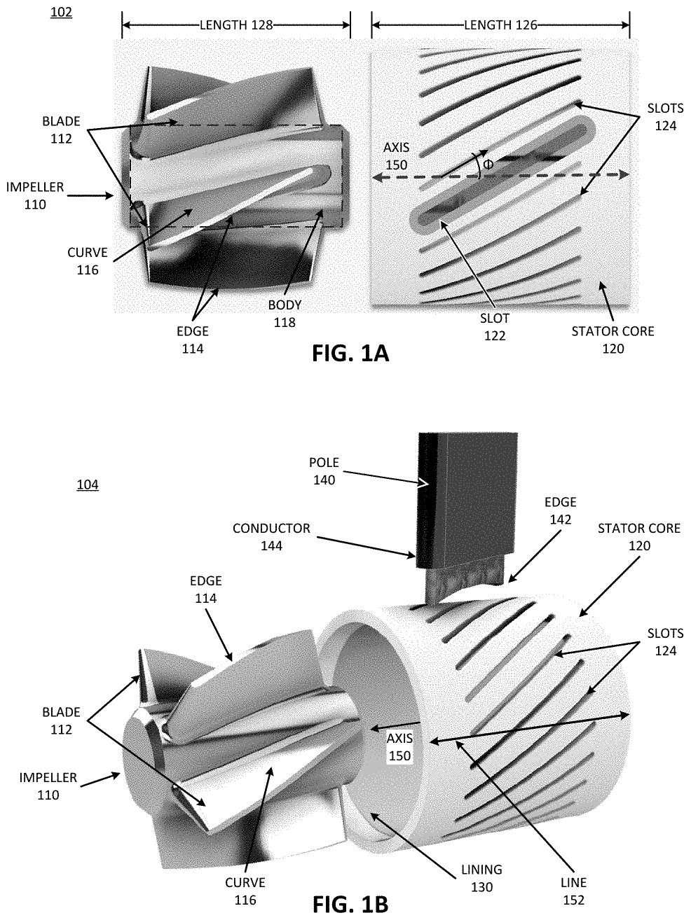

FIG. 1A is a side view of an example of an impeller and stator core for a pump. View 102 illustrates a side view of impeller 110 and stator core 120. Stator core 120 is the body of the stator for the motor assembly. Impeller 110 spins in response to the operation of the motor assembly to pump the fluid inline with the fluid channel. Impeller 110 is made of a magnetic material. Thus, impeller 110 operates as both impeller as well as rotor for the motor. As a rotor, impeller 110 rotates in response to the charging of the stator. The spinning of the rotor is the spinning of impeller 110, which functions to pump the fluid.

Impeller 110 can be any type of magnetic metal. A magnetic metal refers to a metal that has low magnetic reluctance. Low magnetic reluctance is understood to be a relative term, but refers herein to a material that forms a strong temporary magnetic pole in the presence of a magnetic field and is pulled toward the region of higher magnetic flux. Thus, low magnetic reluctance refers to a property of a metal that causes it to be attracted sufficiently to magnetic flux to cause movement of the impeller in response to the creation of magnetic flux in the stator.

Impeller 110 includes body 118, which is outlined by the dashed line. Body 118 has a generally cylindrical shape. In one example, body 118 is a solid body. Impeller 110 includes blades 112, which can alternatively be referred to as vanes or fins. The motion of blades 112 within stator core 120 converts motion into a pressure change that propels the fluid through the center of stator core 120.

In one example, blades 112 rather than being straight have curve 116. Curve 116 will both increase the velocity of the fluid, as well as helping with the electromagnetic operation of the motor, as described in more detail below. In one example, stator core 120 is a length of pipe. Thus, stator core 120 has a cylindrical shape, and is open through the middle. In one example, body 118 of impeller 110 has a length 128 that is close to the same length 126 of stator core 120. Length 126 is the length of axis 150, which refers to a line running through the center point of the opening of stator core 120. In one example, length 128 is shorter than length 126, but is greater than half of length 126. There can be benefit to having length 128 be at least ¾ of length 126.

In one example, blades 112 have edges 114. Edge 114 can be fairly thin. In one example, as seen in view 102, instead of being completely straight, edge 114 has curvature. The curve of edge 114 can at least partially match curve 116 of blade 112. In one example, edge 114 includes at least a portion that is relatively straight. In one example, as seen in the drawing, edge 114 can have a relatively straight portion through the middle of blade 112, and have some curvature on the ends. The straight portion can help blades 112 align with slots 124 of stator core 120, while the curvature at the end can help reduce cogging as different coils of the stator are switched on and off. The curvature can prevent perfect alignment of blade 112 with the slot, which functions to keep the blade in motion, which reduces vibration.

Slot 122 is highlighted in view 102. The highlighted slot shows the shape of slots 124, where slot 122 can be considered part of slots 124, which refers to all the slots around the outer surface or lateral surface of stator core 120. In the slot directly above slot 122, angle θ is illustrated as the angle between axis 150 and slots 124. In one example, slots 124 could be parallel or aligned with axis 150. However, the operation of the pump would be reduced.

In one example, slots 124 are arranged around the lateral surface of stator core 120 at angles. Thus, instead of being inline with a line that runs along the surface, parallel to axis 150, the slots are offset by angle ϕ. In one example, the offset angle is approximately between 25 and 50 degrees. However, other angles can be used. Blades 112 can be generally arranged around body 118 at similar angles on the lateral surface of body 118 of impeller 110. In one example, blades 112 are offset at an angle less than angle ϕ. The blades can thus be arranged on the lateral surface of impeller 110 at an angle less than ϕ, and then curve 116 can curve the blades to cause edge 114 to be at approximately angle ϕ relative to an axis of impeller 110. Thus, the base and the edge of blades 112 can be offset.

FIG. 113 is a perspective view of an example of an impeller and stator core for a pump. View 104 provides a perspective view of stator core 120 and impeller 110 of FIG. 1A. View 104 better illustrates an example of impeller 110 with a cylindrical body 118. Additionally, an example of stator core 120 can be seen as an extended ring or pipe shape.

View 104 illustrates slots 124 of stator core 120, and illustrates pole 140 having edge 142 and conductor 144 to be secured into one of slots 124. In one example, when slots 124 are at an angle with respect to axis 150, edge 142 is not a straight line as it would be when slots are parallel to axis 150. Line 152 represents a line on the lateral surface of the stator core that is parallel with axis 150. Line 152 can be referred to as a surface line or a lateral line. Line 152 extends from one edge of the circular side of stator core 120 to the other edge of the opposite circular side of stator core 120. In addition to extending from edge to edge, line 152 is parallel to axis 150.

In one example, slots 124 are at an angle with respect to line 152, instead of aligning with line 152. When slots 124 are at an angle, pole 140 cannot simply fit directly onto the lateral surface of stator core 120. Rather, pole 140 will connect along a curve along the lateral surface. Thus, edge 142 can be curved to match the curvature of the corresponding slot. Pole 140 includes conductor 144, which represents metal or other conductor wrapped or layered around pole 140. Conductor 144 can be selectively charged by driving a current through the conductor. When conductor 144 conducts a current, the wrappings or windings of conductor 144 around the metal of pole 140 will create an electromagnetic force.

View 104 illustrates another view of an example of blades 112 with curved edges 114 and curve 116 in the blades. It can be observed that impeller 110 will fit within the opening or cavity within stator core 120. The curvature of blades 112 and edges 114 can provide a driving force to move fluid through stator core 120.

View 104 illustrates lining 130, which represents an internal or interior surface of stator core 120. The internal surface can be referred to as a lining, which lines the opening through stator core 120. In one example, stator core 120 is made of magnetic stainless steel and lining 130 is made of non-magnetic stainless steel. Non-magnetic stainless steel has a property of allowing magnetic fields to pass through the metal. Thus, lining 130 can provide a completely sealed fluid channel through stator core 120, while still allowing magnetic flux generated by stator core and pole 140 to pass into the opening within stator core 120. The magnetic flux can thus pass through to attract or pull selected edges 114 of impeller 110 to selected, charged poles 140 of the stator. Thus, lining 130 can be metal as well as being magnetically permeable.

In one example, stator core 120 is made of stainless steel and lining 130 is made of stainless steel, which can cause the two portions to have essentially the same thermal expansion properties. Magnetic stainless steel and non-magnetic stainless steel have nearly the same thermal expansion properties, which can allow for good operation of the pump for very high temperature or very low temperature fluids. A very high temperature fluid operates at a temperature that is at least an order of magnitude higher than ambient temperature. A very low temperature fluid operates at a temperature that is at least an order of magnitude lower than ambient temperature.

In one example, lining 130 is approximately 2-3 mm thick. In one example, lining 130 does not have to be thick when the fluid channel does not need to be pressurized. The fluid channel would not need to be pressurized if the fluid used has a low thermal expansion characteristic. Such a scenario is different, for example, than the use of water in a high temperature system, which turns to steam. Steam has a very high thermal expansion, which requires pressurizing the system.

As illustrated in view 104, in one example, stator core 120 is a slotted pipe that mechanically captures the poles. Lining 130 of stator core 120 can isolate the fluid and eliminate penetrations into the sealed system. The sealed system refers to the isolated or sealed fluid channel. Lining 130 can be referred to as a sleeve liner. In one example, lining 130 should be made to have a similar coefficient of thermal expansion as stator core 120.

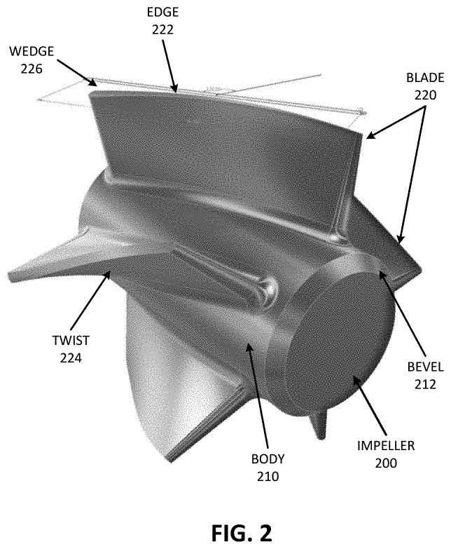

FIG. 2 is a perspective view of an example of a floating impeller for a pump. Impeller 200 illustrates an impeller in accordance with an example of impeller 110 of FIG. 1A. The impeller can also be referred to as a compressor.

In one example, impeller 200 has a cylindrical body 210 with blades 220 that extend from the body. Each blade 220 has an edge 222. In one example, each blade 220 has twist 224. Twist 224 can be a helix shape or helical twist in the center of the blades or fins. Thus, impeller 200 can be an impeller/compressor that is like a rotor for a switched reluctance motor with a helical twist. In one example, impeller 200 is a cartridge.

In one example, impeller 200 is self-centering due to journal bearing. A journal bearing is a fluid bearing floating over a surface due to compression of the fluid. Impeller 200 has edge 222 with wedge 226 at the ends, referring to the blade portions closest to the circular caps on body 210. The wedge shape of wedge 226 has a vertical difference from an apex of the edge 222. A difference of just a couple of millimeters provides a compression effect on the liquid as the liquid is compressed between edge 222 of blade 220 and an inner surface of the stator core. In one example, the vertical difference of wedge 226 is approximately 0.5 mm to 2 mm. As fluid passes between edge 222 and the sidewall of the interior surface of the stator core, there is a foil effect or foil bearing based on the motion of the blade, which can eliminate the need for other bearings.

In one example, body 210 includes a beveled end. Bevel 212 represents the bevel for impeller 200. Bevel 212 provides structural features for body 210 to provide bearing function for impeller 200. Bevel 212 can engage with a thrust bearing at an end or of a cap of the stator core in which impeller 200 will be used. For example, a thrust bearing can be implemented as a shoe bearing or a tilting pad bearing, commonly referred to as a KINGSBURY bearing, such as those available from MESSINGER BEARINGS. All trademarks are the property of their respective owners, and are used here merely for identification.

In one example, body 210 is made of magnetic metal. In one example, body 210 and blades 220 are made of the same metal. In one example, blades 220 are mounted on body 210 and have a different metal composition from body 210. Both blades 220 and body 210 are made of magnetic metal. In one example, edge 222 is coated with a wear-resistant coating. In one example, bevel 212 is coated with a wear-resistant coating. In addition to bevel 212 being coated, the end of body 210 can be coated as well. Whether for the coating for edge 222 or the coating for bevel 212, in one example, the wear-resistant coating includes a different type of metal or metal compound as the edge or bevel. In one example, the wear-resistant coating includes a ceramic material. In one example, the wear-resistant coating includes a coating having a crystalline structure. The crystalline structure can be or include aluminum oxide or sapphire. The crystalline structure can include crystalline carbon or diamond.

Blades 220 include twist 224, which represents a curve or twist in the body of blades 220. In one example, twist 224 represents a helical twist in blade 220. In one example, the helical shape is unconstrained. Impeller 200 can be formed with blades 220 in the helical shape by stacking laminates with layers being rotated (e.g., staircase laminates). The number of blades 220 is unconstrained, and can be an even number of blades or an odd number of blades. The shape of impeller 200 is one example of a possible shape, and other shapes can be used, depending on the application in which the impeller will be used. A planar blade is typically the least expensive to make, but more complex shapes can also be easily made and may be comparable in price.

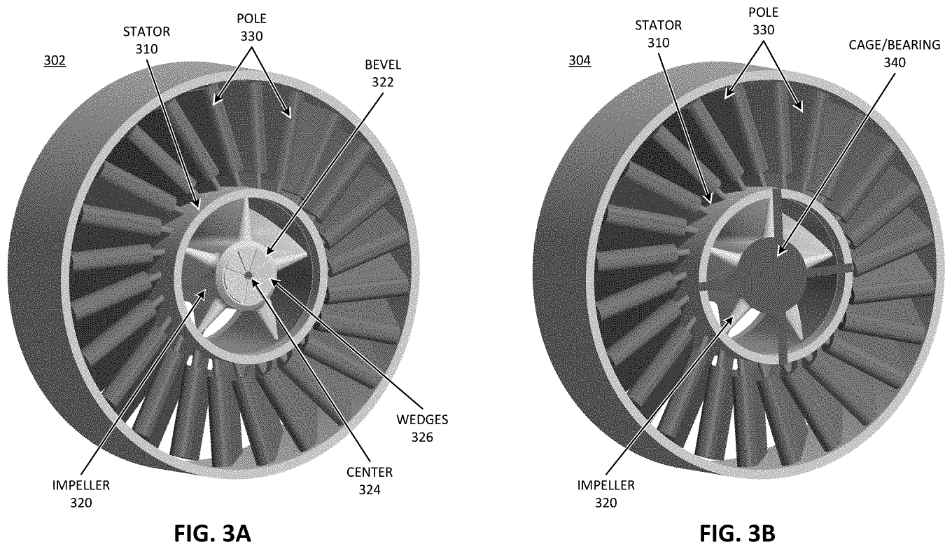

FIG. 3A is an example of a pump stator and impeller with a foil bearing on an end of the impeller. Stator 310 represents the stator, with a cylindrical or pipe shaped stator core having poles extending from the surface with conductor to provide electromagnetic operation. Impeller 320 is an impeller/compressor in accordance with an example of impeller 200 of FIG. 2, and acts as the rotor for pump 302.

Pump 302 includes stator 310, which includes poles 330, which represent metallic fins mounted in the slots of the lateral surface of the stator core, and having conductor wrapped around the metal fins. It can be observed from the example of pump 302, that the poles are much longer than would be expected for a traditional stator. Poles 330 extend away from the stator core and away from the cavity surrounded by stator 310, or the center through stator 310. Thus, poles 330 can extend out as long as needed, seeing that the opening through stator 310 is inline with, and made to be part of, the isolated fluid channel.

In general, poles 330 can be as large as needed to meet the field strength requirements. Poles 330 need to be longer than a typical stator coil would be, given that the magnetic field needs to pass through the stator core lining to the blades of impeller 320. The individual poles have good manufacturing properties, seeing that they are easily wrapped with conductor.

In one example, impeller 320 includes bevel 322 on an end that will bear the thrust force generated when stator 310 causes impeller 320 to rotate. Center 324 represents a center point of the end of impeller 320. In one example, impeller 320 includes wedges 326 or wedge shapes on the end of the impeller body, on the side of the impeller that will bear the thrust force.

The wedge shapes can be narrower and thinner near center 324, and wider and taller nearer bevel 322. The shape of wedges 326 can enable the end of impeller 320 to operate as a foil bearing, compressing fluid against a plate or bearing structure, such as what is described for FIG. 3B. In one example, center 324 includes a hole that includes a fluid channel to the lateral surface of the cylindrical body of impeller 320. The impeller body can include fluid channel openings (not specifically illustrated) to cause fluid to enter through the openings towards a low pressure region in line with center 324. Thus, the fluid will be forced out center 324 to provide a constant flow of working fluid through center 324 to provide the fluid for the foil bearing operation.

FIG. 3B is an example of the pump stator and impeller of FIG. 3A with a bearing structure over the stator core. In one example, pump 304 includes cage/bearing 340 over an end of stator 310. In one example, cage/bearing 340 is over the end in direction of fluid flow. In one example, there is a cage or bearing component over the opposite end of the opening through stator 310, referring to the end that is not visible in pump 304. Bearings can be on both sides if the flow needs to be bidirectional.

In one example, cage/bearing 340 includes a bearing to address the thrust load that will be produced with motion of impeller 320. In one example, the bearing function of cage/bearing 340 can handle the thrust load by hydrodynamic bearings, such as what is illustrated for an example of impeller 320. Hydrodynamic forces can control the radial load and position of the impeller. In one example, the bearing function of cage/bearing 340 can handle the thrust load by a shoe bearing.

Cage/bearing 340 can hold impeller 320 within the cylindrical opening of stator 310, and other than the bearings that constrain the movement within the opening within stator 310, impeller 320 is completely free-floating. It will be understood that with the seal within the interior surface of stator 310, impeller 320 floats within the fluid channel, and nothing penetrates the fluid channel except the magnetic fields generated by poles 330. Even with extended size and possibly additional winding required on the poles, the value of a single part with no shaft seals, no mechanical bearings, and no other structures or systems that need repair or maintenance can more than compensate for the small decrease in efficiency and torque due to the design of pump 304. The lack of shaft seal and mechanical bearings significantly reduces the potential for leaks, corrosion, or failure of the motor and pump combination. The improvements in sealing the system with low failure potential also enables deployment of a pump in accordance with pump 304 in an environment that would be unsafe for human maintenance workers, or otherwise present challenges or extreme cost for maintenance. Pump 304 can provide for extended maintenance-free operation, which allows such a deployment.

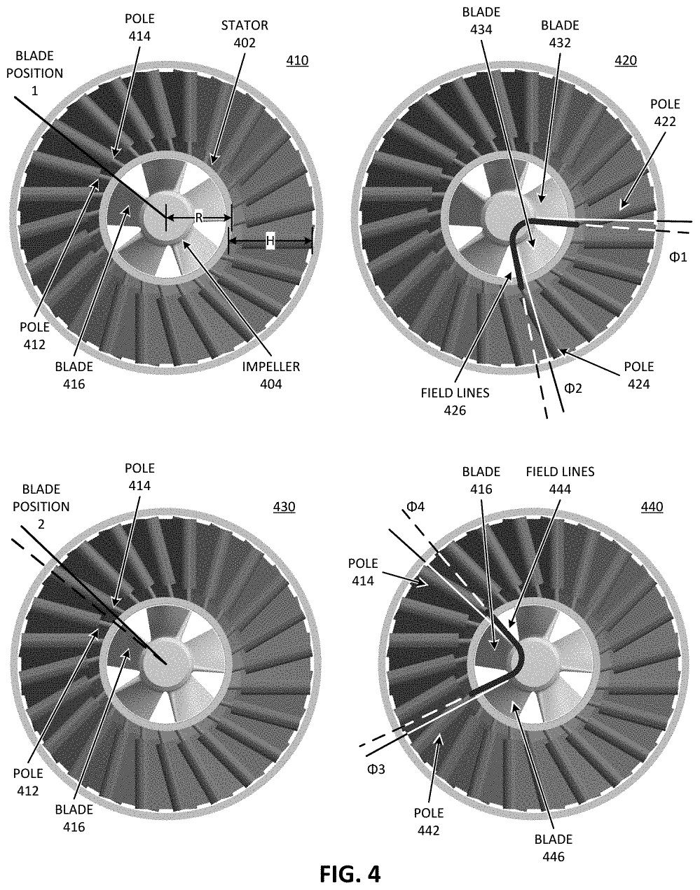

FIG. 4 is an example of magnetic reluctance operation for a pump assembly. There are four views, view 410, view 420, view 430, and view 440, which illustrate different states of an integrated motor and pump in accordance with an example of pump 302 or pump 304.

View 410 illustrates an example of relative length of poles to the stator core. In one example, the poles of stator 402 have a length that is longer than a traditional motor because the magnetic density is reduced through the lining of the stator core. In one example, the poles can be up to three times (3×) as long as a normal motor, which can make up for the larger magnetic field gap due to the liner (e.g., stainless steel liner) of the stator core. It will be understood that the loss of efficiency has less impact on the system than would otherwise occur in a traditional system due to the pump being entirely enclosed. As illustrated, the radius of the stator core has a length of R (radius). The poles are illustrated to have a length of H (height). In one example, H>R. In one example, H is approximately equal to R. In one example, H can be approximately 2*R, or approximately the diameter of the opening. In one example, H is greater than the diameter.

It will be understood that the combined motor and pump operates on the principles of a switched reluctance motor. With principles of switched reluctance, the fins or blades of the rotor (impeller 404) will rotate or spin to align themselves with the slots of the charged poles, to minimize the length of the magnetic flux path. As the coils are selectively switched, the changing electromagnetic fields will cause the rotor to turn.

Typically, the operation of a switched reluctance motor is thought of in two dimensions, because the magnetic flux tends to flow in ways that can be described in two dimensions. The motor and impeller can be arranged in such a two-dimensional design, with fins on impeller 404 that are mostly straight and aligned with radius lines, and poles that are also aligned with radius lines. In one example, with a twist or curve in the blades of impeller 404, the blades tangentially intersect the radial lines of stator 402 instead of aligning with them. In one example, the slots are arranged on a curve along the outer surface of stator 402, which will allow the alignment of the curved blades of impeller 404 with the slots on the angle. Added with the cylindrical length of impeller 404 and the length of the internal cylindrical opening within stator 402, and the system design is a three-dimensional (3D) switched reluctance motor instead of a traditional switched reluctance motor that has two dimensions of magnetic flux. The magnetic flux is created by the poles of stator 402, which interact in three dimensions with the blades of impeller 404.

In one example, the pitch angle of the pump blades of impeller 404 is slightly different than the angle of the poles of stator 402, which can reduce cogging. In one example, impeller has an odd number of blades and stator 402 has an even number of poles. The odd ratio of poles between stator and rotor can also reduce cogging. In an implementation with twists in the impeller blades and stator poles offset at an angle, the cylindrical wrapping of the coils can overlap with the helical wrap of the impeller, which will cause smoother magnetic circuit engagement, reducing noise and vibration of the system as impeller 404 spins.

Even in three dimensions, the motor function basic operating principle of the motor is essentially the same as a traditional switched reluctance motor, in that the fins of impeller 404 will try to center with the slot of the charged pole, to align with the magnetic field. In one example, such as with an impeller in accordance with an example of impeller 200 of FIG. 2, the blades can have a helical twist, which can result in a slightly arched shape of the blade. With such a structure, even as the majority of the blade aligns with the magnetic field, some of the blade edge will end up not aligned with the magnetic field, but instead be partway to the next slot. Such operation is possible because of the 3D structure and 3D switched reluctance operation. The helix of the impeller blades and the curve of the slots on the curve along the outer surface of the stator core can reduce cogging and reduce vibration of the impeller because of the fact that the blades do not perfectly align with the coils.

Thus, in one example, the impeller shape and the stator structure reduce the magnetic flux alignment, reducing the efficiency due to increasing the complexity of the flux lines. Additionally, there are losses by increasing the air gap by introducing a stainless steel or other non-ferromagnetic material into the gap, we may reduce the flux at least a little bit compared to air, but the metal lining can contain the internal fluid and result in a sealed or isolated fluid channel. Additionally, the system can also experience loss of efficiency due to eddy current losses at high speeds. Regardless of the efficiency losses, the sealed system can make up for the loss of efficiency.

When the coils on stator 402 provide electromagnetic poles when charged. The blades of impeller 404 provide temporary magnetic poles in response to the electromagnetic field created by the coils of the stator. When the rotor and stator poles are out of alignment, there is higher magnetic reluctance between them. A controller (not specifically shown) causes a current pass through the conductors, which energizes at least two of the stator poles. The stator poles are energized to create one or more pairs of north-south poles. In response to the energizing of the pole pairs, impeller 404 turns to align the blades with the energized poles of stator 402, which minimizes the reluctance of the magnetic circuit.

In view 410, the radial line from the center of impeller 404 shows the alignment or blade position 1 of blade 416 of impeller 404. It can be observed that blade position 1 is between pole 412 and pole 414 of stator 402. Thus, in blade position 1, blade 416 is not aligned with the slot in the stator.

In view 420, pole 422 and pole 424 are energized as a north-south pair. The dark line illustrates field lines 426 between the poles. The field line extends from pole 422 through the stator core, through blade 432, through the body of the impeller, through blade 434, and through the stator core to pole 424. The direction of the magnetic flux could be the reverse of what was described (i.e., from pole 424 to pole 422). The dashed lines illustrate the alignment of the magnetic flux with the poles.

The solid lines illustrate that when the poles are charged, the blades of impeller 404 are not initially aligned with field lines 426. Rather, blade 432 is offset by an angle ϕ1 and blade 434 is offset by an angle ϕ2. In one example, ϕ1 and ϕ2 are different from each other. The charging of the poles will cause impeller 404 to spin to bring blade 432 as close to aligned with pole 422 as possible, while also aligning blade 434 as closely as possible with pole 424.

View 430 illustrates the result of the rotation of impeller 404 based on the charging of the poles in view 420. It can be observed that blade position 2 of blade 416 is different than blade position 1, where the dashed line represents blade position 1 and the solid line represents blade position 2. Blade position 2 can be offset from blade position 1 by ϕ1 or ϕ2, or some angle between them if the angles are different from each other. It can be observed that the rotation of impeller 404 to put blade 416 in blade position 2 does not align blade 416 with pole 414, although it is closer to aligned.

In view 440, pole 442 and pole 414 are energized as a north-south pair. The dark line illustrates field lines 444 between the poles. The field line extends from pole 442 through the stator core, through blade 446, through the body of the impeller, through blade 416, and through the stator core to pole 414. As described above, the direction of the magnetic flux could be the reverse of what was described (i.e., from pole 414 to pole 442). The dashed lines illustrate the alignment of the magnetic flux with the poles.

The solid lines illustrate that when the poles are charged, the blades of impeller 404 are not initially aligned with field lines 444. Rather, blade 446 is offset by an angle ϕ3 and blade 416 is offset by an angle ϕ4. In one example, ϕ3 and ϕ4 are different from each other. In one example, ϕ3 and ϕ4 are the same, respectively, as ϕ1 and ϕ2, although there is no requirement that any of the angles be the same, depending on the configuration of poles and blades. The charging of the poles will cause impeller 404 to spin to bring blade 446 as close to aligned with pole 442 as possible, while also aligning blade 416 as closely as possible with pole 414.

The operation of the motor will continue to charge pairs of poles, causing impeller 404 to continue to rotate. The operations described can occur very quickly, resulting in rotations up to hundreds of rotations per minute (RPM) or RPM in the thousands for impeller 404.

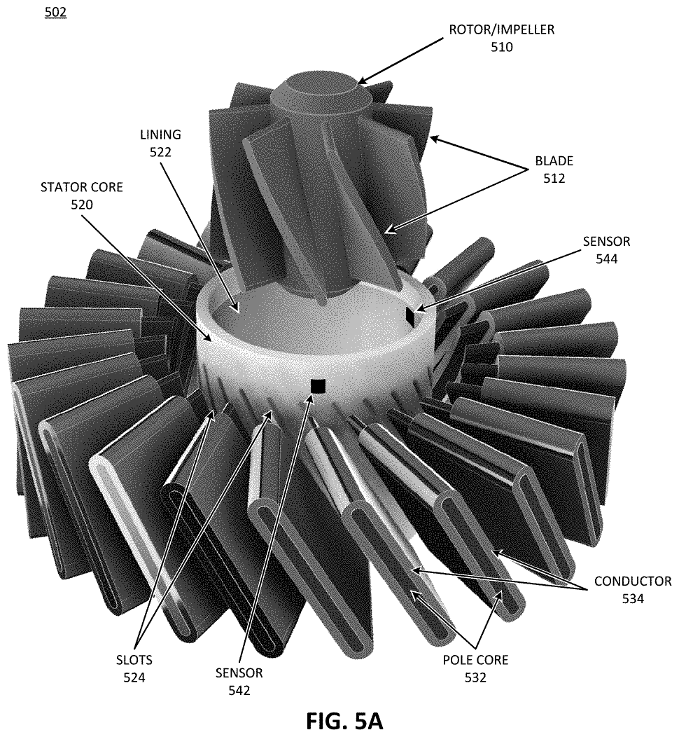

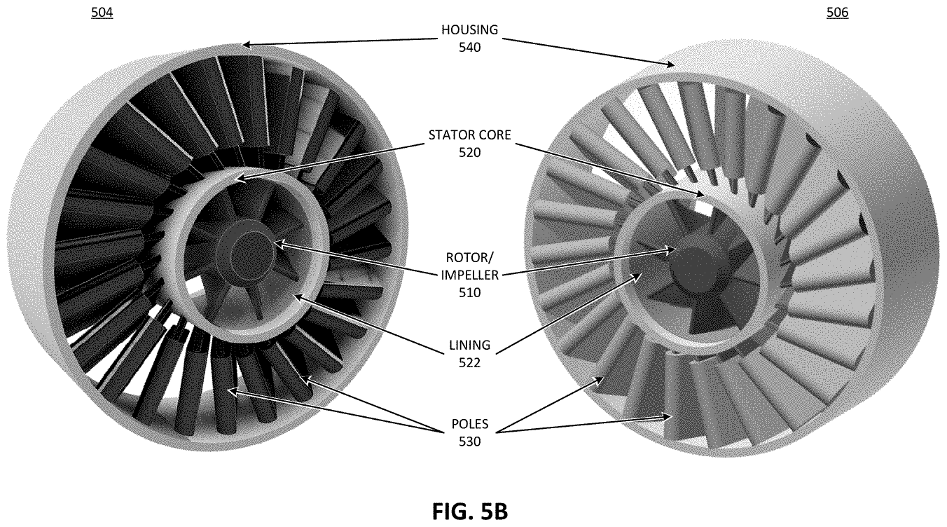

FIG. 5A is an example of a pump assembly. System 502 illustrates a perspective view of the components of a stator and impeller decoupled from each other. System 502 can be a system in accordance with an example of pump 302 or pump 304.

System 502 includes rotor/impeller 510, which includes an impeller body and blades 512. In one example, rotor/impeller 510 includes at least one beveled end to engage with a thrust bearing that will cover the end of the opening of stator core 520. Stator core 520 includes slots 524 on the outer surface, to mechanically receive the poles.

System 502 illustrates the poles as having pole core 532, which is a ferroelectric metallic material wrapped with conductor 534. In one example, conductor 534 can be traditional round wire. In one example, conductor 534 includes flat wire or ribbon wire. The number of windings and the configuration of the wires can be different for different systems. In one example, conductor 534 around pole core 532 is copper wire wrapped around a steel plate.

System 502 illustrates lining 522 on the internal surface or interior surface of stator core 520. Lining 522 can be a non-magnetic or non-ferromagnetic material. Thus, lining 522 allows magnetic flux generated by the poles to pass through to the opening of stator core 520. The passing through of the magnetic flux will allow for the switched reluctance operation in accordance with what is described above.

The perspective view of system 502 illustrates the angled offsets of blades 512 of rotor/impeller 510, as well as the angled offsets of the poles around stator core 520. In one example, system 502 can have straight blades and poles, which would result in a 2D (two-dimensional) switched reluctance motor, whereas the angled offsets provide a 3D switched reluctance motor.

In one example, as illustrated in system 502, a pump and motor can be integrated, where the pump assembly includes a stator core having a cylindrical shape. The stator core has a cylindrical opening through a center to bound the fluid channel. The stator has electromagnetic coils arranged around a lateral surface of the stator core extending away from the center of the stator core. The impeller operates as a rotor, to spin within the cylindrical opening of the stator core in response to selective charging of the electromagnetic coils.

In one example, system 502 includes a control loop where signals from the switched reluctance motor controller (not specifically shown in system 502) are attenuated to correct for vibrations or turbidity or efficiency of the motor at a particular speed. In one example, system 502 includes sensors on the outside or inside to supply data for a control loop that allows operating within parameters of sounds, temperature, vibration, radioactivity, chemical potential, clock time, operating time, fluid speed, fluid pressure, time duty cycle, or other operating parameter, or a combination of these. In one example, system 502 includes one or more sensors to provide feedback to a controller. A controller will control the application of current to the poles to control the electromagnetic fields created to turn rotor/impeller 510. Sensor 542 represents an example of a sensor on an outside of the fluid channel. Sensor 544 represents a sensor on an inside of the fluid channel. A sensor on the inside of the channel could provide non-wired communication to the controller to maintain the seal of the fluid channel. In one example, a sensor extends through stator core 520 from outside the channel to the inside of the channel. As long as such a sensor seals with lining 522, the isolation of the fluid channel can remain undisturbed by the use of one or more sensors. In one example, system 502 utilizes multiple sensors in different locations around stator core 520. In one example, system 502 utilizes multiple sensors, including one or more sensors inside stator core 520 and one or more sensors outside stator core 520.

FIG. 5B is an example of a pump assembly with an outer housing. System 504 represents the assembly of system 502 within a housing, as seen from one perspective. System 506 represents the assembly of system 502 within a housing, as seen from another perspective.

Both system 504 and system 506 illustrate stator core 520 having poles 530 extending from the outer surface. Rotor/impeller 510 is positioned within the opening through stator core 520. Lining 522 seals the fluid channel, and only magnetic flux from poles 530 will enter the fluid channel. Housing 540 surrounds the combined motor and pump assembly. Further housing components can be arranged around the face of housing 540.

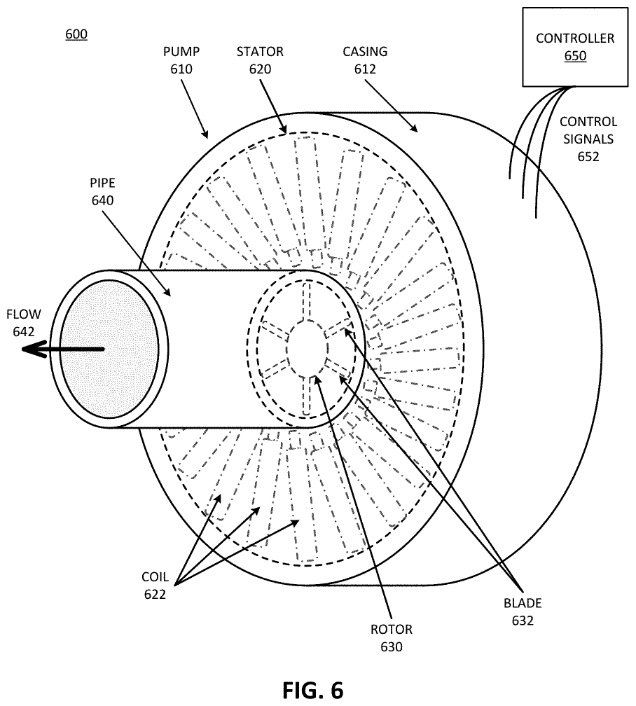

FIG. 6 is an example of a pump assembly coupled to a pipe. System 600 represents a pump and motor assembly in accordance with an example of system 504 and an example of pump 302 or pump 304.

System 600 illustrates pump 610, which is an integrated pump and motor in accordance with any description herein. Casing 612 represents the housing of pump 610. Inside casing 612 is stator 620, which includes a stator core and coils 622, in accordance with any description herein. Within an inside of the stator core is rotor 630 having blades 632.

System 600 illustrates pipe 640 connected to pump 610. In one example, pipe has an inner diameter that matches the internal diameter of the stator core of stator 620. Thus, the opening through stator 620 in which rotor 630 (or the impeller) is positioned, can align exactly with the internal diameter of pipe 640. Flow 642 represents a flow of liquid through pipe 640.

It will be understood that pump 610 can be made to different specifications depending on the liquid to be pumped. Pump 610 can have dimensions to match the interior of stator 620 with the inner diameter of pipe 640, with other components scaled to meet needs for impeller speed and system operation. Pipe 640 can have a diameter up to 1 or more meters, or down to millimeters in diameter, depending on the application.

The application can depend on the system where the piping and pump are used, as well as the fluid to be pumped. Due to the sealed nature of the fluid channel through pump 610, the pump can work with extreme temperature liquids, such as very hot liquids or very cold liquids. In one example, the fluid is an ionic fluid or molten salt. Such applications can be for solar systems, nuclear generators, thermal generators, or other systems that transfer heat with high temperature fluid. In one example, the fluid is a cryogenic fluid or liquid. Cryogenic fluids have temperatures well below 0 degrees C. The sealing of the fluid channel for pump 610 also makes the pump appealing for food grade liquids, seeing there is no contamination into the system. Thus, liquid dairy products or other liquid food products can be the fluid for pump 610. The sealing of the fluid channel for pump 610 also makes the pump appealing for industrial chemicals or other fluids that would cause contamination if they escaped outside the fluid channel. Thus, the sealing of the fluid channel can prevent contamination of the outside environment from a fluid that would cause harm or damage, such as industrial chemicals or oil or gas products. It will be understood that the example applications are not limited to what is described here.

System 600 includes controller 650, which represents a controller to control the charging or the energizing of coils 622. Controller 650 can include one or more control signals 652 that control the flow of current through coils 622 to cause the spinning of rotor 630.

Controller 650 can represent an electronic control system that switches on the windings of successive pairs of stator poles in sequence to cause rotation of rotor 630. To maintain rotation of rotor 630, controller 650 will typically switch poles of stator 620 to generate magnetic fields that lead the rotor pole, pulling the rotor toward the charged stator pole. Controller 650 can precisely time the energizing of coils 622 to ensure it occurs as the rotor pole is approaching alignment with the energized stator pole. In one example, controller 650 operates based on feedback from one or more sensors, such as what is described with reference to system 502. In one example, controller 650 can be a smart controller that enables radial magnetic levitation, similar to what is applied by high-speed turbo molecular pumps.

In general with respect to the descriptions herein, in one example a pump includes: a stator core having a cylindrical shape with a cylindrical opening through a center of the cylindrical shape; electromagnetic coils arranged around a lateral surface of the stator core extending away from the center of the stator core; and an impeller to spin within the cylindrical opening in response to selective charging of the electromagnetic coils, wherein the impeller includes a cylindrical body having blades that extend from the cylindrical body, wherein the selective charging of the electromagnetic coils is to cause the blades on the impeller to align with the electromagnetic coils to create a magnetic flux path between selected coils through the impeller.

In one example of the pump, the impeller to spin comprises the impeller to pump a fluid. In any preceding example of the pump, the fluid comprises an ionic fluid or molten salt. In any preceding example of the pump, the fluid comprises a food product. In any preceding example of the pump, the fluid comprises an industrial chemical. In any preceding example of the pump, the fluid comprises a cryogenic fluid. In any preceding example of the pump, the cylindrical opening has an inner surface of non-magnetic stainless steel. In any preceding example of the pump, the stator core has an even number of electromagnetic coils arranged around the lateral surface and wherein the impeller has an odd number of blades. In any preceding example of the pump, the electromagnetic coils comprise conductor wrapped around poles mechanically connected to slots of the stator core. In any preceding example of the pump, the poles include a curve edge to connect on an angle to the lateral surface of the stator core. In any preceding example of the pump, the slots have a length approximately equal to a diameter of the cylindrical opening. In any preceding example of the pump, the body of the impeller having a length of approximately equal to a length of an axis of the stator core. In any preceding example of the pump, the blades of the impeller having an edge shape to compress liquid against an inner surface of the cylindrical opening while the impeller spins, to create a foil bearing based on motion of the blades. In any preceding example of the pump, the impeller and blades are magnetic metal, and wherein blades have a wear-resistant coating. In any preceding example of the pump, the wear-resistant coating comprises a different metal. In any preceding example of the pump, the wear-resistant coating comprises ceramic. In any preceding example of the pump, the wear-resistant coating comprises a coating having a crystalline structure. In any preceding example of the pump, the crystalline structure comprises sapphire or diamond. In any preceding example of the pump, the blades comprise a helix curve. In any preceding example of the pump, the pump further includes a structure over the cylindrical opening at one end of the stator core, the structure including a thrust bearing for axial load of the impeller. In any preceding example of the pump, the impeller and blades are magnetic metal, and wherein the body of the impeller includes a beveled end to engage with the thrust bearing. In any preceding example of the pump, the beveled end includes a wear-resistant coating of a ceramic or a crystalline coating.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

1. A pump comprising:
a stator core having a cylindrical shape with open ends and a sealed lateral surface to form a sealed cylindrical channel through a center of the cylindrical shape;
electromagnetic coils arranged around an outside of the sealed lateral surface of the stator core, and extending from the lateral surface away from the sealed cylindrical channel; and
an impeller to spin within the sealed cylindrical channel, inside the sealed lateral surface, in response to selective charging of the electromagnetic coils, wherein the impeller includes a cylindrical body having blades that extend from the cylindrical body, wherein the selective charging of the electromagnetic coils is to cause the blades on the impeller to align with the electromagnetic coils to create a magnetic flux path between selected coils through the impeller;
wherein the electromagnetic coils comprise conductors wrapped around poles mechanically connected to slots in the lateral surface of the stator core, wherein the poles include a curved edge to connect on an angle to the lateral surface of the stator core.

2. The pump of claim 1, wherein the impeller is to pump a fluid, wherein the fluid comprises an ionic fluid or molten salt.

3. The pump of claim 1, wherein the impeller to spin comprises the impeller to pump a fluid, wherein the fluid comprises a food product.

4. The pump of claim 1, wherein the impeller to spin comprises the impeller to pump a fluid, wherein the fluid comprises an industrial chemical.

5. The pump of claim 1, wherein the impeller to spin comprises the impeller to pump a fluid, wherein the fluid comprises a cryogenic fluid.

6. The pump of claim 1, wherein the cylindrical opening has an inner surface of non-magnetic stainless steel.

7. The pump of claim 1, wherein the stator core has an even number of electromagnetic coils arranged around the lateral surface and wherein the impeller has an odd number of blades.

8-9. (canceled)

10. The pump of claim 1, wherein the slots have a length substantially equal to a diameter of the cylindrical opening.

11. The pump of claim 1, wherein the cylindrical body of the impeller having a length substantially equal to a length of an axis of the stator core.

12. The pump of claim 1, wherein the blades of the impeller having an edge shape to compress liquid against an inner surface of the cylindrical opening while the impeller spins, to create a foil bearing based on motion of the blades.

13. The pump of claim 12, wherein the impeller and blades are magnetic metal, and wherein blades have a wear-resistant coating.

14. The pump of claim 13, wherein the wear-resistant coating comprises a different metal.

15. The pump of claim 13, wherein the wear-resistant coating comprises ceramic.

16. The pump of claim 13, wherein the wear-resistant coating comprises a coating having a crystalline structure.

17. The pump of claim 16, wherein the crystalline structure comprises sapphire or diamond.

18. The pump of claim 1, wherein the blades comprise a helix curve.

19. The pump of claim 1, wherein further comprising a structure over the cylindrical opening at one end of the stator core, the structure including a thrust bearing for axial load of the impeller.

20. The pump of claim 19, wherein the impeller and blades are magnetic metal, and wherein the cylindrical body of the impeller includes a beveled end to engage with the thrust bearing.

21. The pump of claim 20, wherein the beveled end includes a wear-resistant coating of a ceramic or a crystalline coating.
